(19) United States
(12) Patent Application Publication
(10) Pub. No.: US 2012/0127094 A1
(43) Pub. Date: May 24, 2012

(54) TOUCH SCREEN PANEL AND DISPLAY DEVICE HAVING THE SAME

(76) Inventor: Hwan-Hee Jeong, Yongin-city (KR)

(21) Appl. No.: 13/098,282

(22) Filed: Apr. 29, 2011

(30) Foreign Application Priority Data
Nov. 18, 2010 (KR) 10-2010-0115185

(51) Int. Cl. G06F 3/041

(52) U.S. Cl. 345/173

(57) ABSTRACT

A touch screen panel includes: a substrate; a sensor that is disposed at the center of the substrate; a metal wire pattern that is disposed at a periphery of the sensor and that has at least a portion that is connected to the sensor; an insulation layer that covers the metal wire pattern; and a ground line that is disposed between the edge of the substrate and the metal wire pattern.

### CROSS-REFERENCE TO RELATED APPLICATION

This application claims priority to and the benefit of Korean Patent Application No. 10-2010-0115185, filed in the Korean Intellectual Property Office, on Nov. 18, 2010, the entire content of which are incorporated herein by reference.

### BACKGROUND

1. Field

The described technology relates generally to a touch screen panel and a display device having the same.

2. Description of Related Art

Nowadays, a flat panel display that can be carried or that is portable has been in the spotlight as a desired display device. A flat panel display that can be easily carried includes an organic light emitting diode (OLED) display, a liquid crystal display (LCD), an electrophoretic display, etc.

Further, in the flat panel display that can be carried, application of a touch function that can input an instruction through a method of touching a screen with a finger or a pen type indication device is desired. Accordingly, by attaching a touch screen panel to a display panel that displays an image, a display device having a touch function is formed.

A touch screen panel can be a capacitive overlay panel, a resistive overlay panel, a surface acoustic wave panel, an infrared panel, etc.

However, when external static electricity is injected into a metal wire pattern that is disposed at the edge of a touch screen panel, disconnection occurs in a sensor and thus a problem of a sensing failure occurs.

The above information disclosed in this Background section is only for enhancement of understanding the background of the described technology and therefore it may contain information that does not form the prior art that is already known in this country to a person of ordinary skill in the art.

### SUMMARY

The described technology has been made in an effort to provide a touch screen panel capable of preventing a failure from occurring due to static electricity and a display device having the same.

An exemplary embodiment provides a touch screen panel including: a substrate; a sensor that is disposed at the center of the substrate; a metal wire pattern that is disposed at a periphery of the sensor and that has at least a portion that is connected to the sensor; an insulation layer that covers the metal wire pattern; and a ground line that is disposed between the edge of the substrate and the metal wire pattern.

The touch screen panel may further include a window member that is arranged opposite to (or to face) the substrate with the sensor interposed therebetween; and an adhesive layer that fills space between the window member and the substrate.

The touch screen panel may further include a light blocking layer that is formed in an area of the window member that faces (or is opposite to) the metal wiring pattern.

The ground line may be extended from between the edge of the substrate and the metal wire pattern, onto the insulation layer that covers the metal wire pattern.

Another embodiment provides a display device including: the touch screen panel; and a display panel that is arranged opposite to the substrate of the touch screen panel.

According to exemplary embodiments, a touch screen panel and a display device having the same can prevent a failure from occurring due to static electricity.

### BRIEF DESCRIPTION OF THE DRAWINGS

FIG. 1 is a layout view illustrating a touch screen panel according to a first exemplary embodiment.

FIG. 2 is a partially cross-sectional view illustrating the touch screen panel of FIG. 1 and a display device having the same.

FIG. 3 is a partially cross-sectional view illustrating a touch screen panel and a display device having the same according to a second exemplary embodiment.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Like reference numerals designate like elements throughout the specification. Further, in a second exemplary embodiment other than a first exemplary embodiment of several exemplary embodiments, elements different from those of the first exemplary embodiment will be described.

Further, in the drawings, a size and thickness of each element are randomly represented for better understanding and ease of description, and the present invention is not limited thereto. In the drawings, the thickness of layers, films, panels, regions, etc., are exaggerated for clarity. In the drawings, for better understanding and ease of description, thicknesses of some layers and areas are excessively displayed.

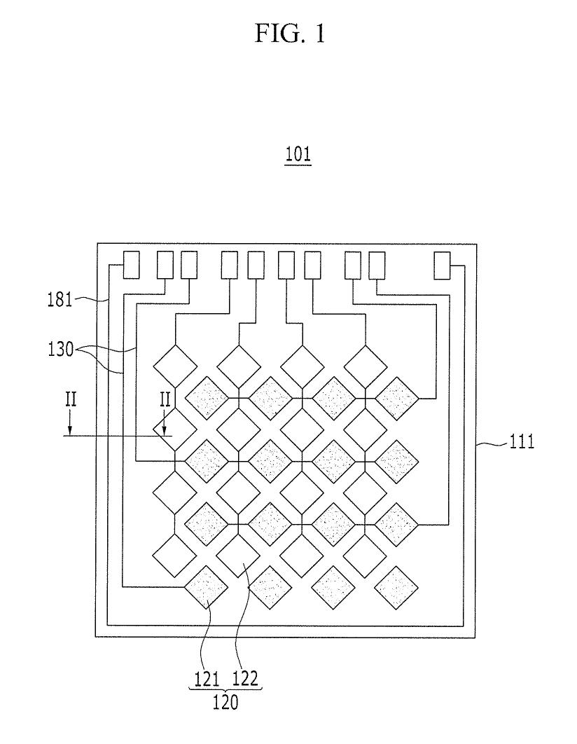

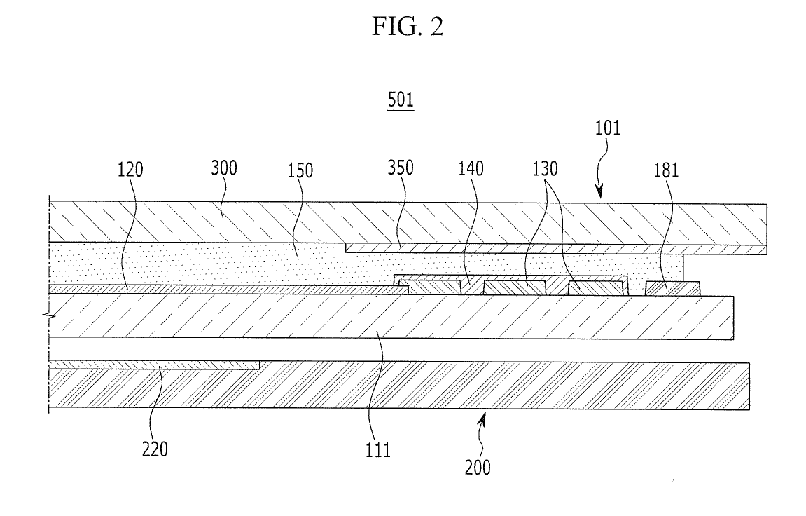

Hereinafter, a touch screen panel 101 and a display device 501 having the same according to the first exemplary embodiment will be described with reference to FIGS. 1 and 2.

As shown in FIGS. 1 and 2, the touch screen panel 101 includes a substrate 111, a sensor 120, a metal wire pattern 130, an insulation layer 140, and a ground line 181. Further, the touch screen panel 101 may include a window member 300, a light blocking layer 350, and an adhesive layer 150.

The substrate 111 is made of a transparent insulation material composed of glass, quartz, ceramic, plastic, etc. When the substrate 111 is made of plastic, the substrate 111 may be formed as a flexible substrate. Specifically, plastic that can be used as a material of the substrate 111 may be an insulation organic material and may be an organic material that is selected from polyethersulphone (PES), polyacrylate (PAR), polyetherimide (PEI), polyethyelene napthalate (PEN), polyethyeleneterepthalate (PET), polyphenylene sulfide (PPS), polyallylate, polyimide, polycarbonate (PC), cellulose triacetate (TAC), and/or cellulose acetate propionate (CAP).

The sensor 120 is made of a transparent conducting material and disposed at the center of the substrate 111. Further, the sensor 120 includes a first sensor 121 and a second sensor 122. In this case, the first sensor 121 and the second sensor 122 may be formed in different layers or in the same layer. When the first sensor 121 and the second sensor 122 are formed in the same layer, the first sensor 121 and the second sensor 122 are separated from each other so as to be insulated from each other. The first sensor 121 and the second sensor 122 may be arranged to intersect or cross each other.

The metal wire pattern 130 is disposed at a periphery of the sensor 120. At least a part (i.e., all or a part) of the metal wire pattern 130 is connected to the sensor 120. When the sensor 120 is divided into the first sensor 121 and the second sensor 122, the metal wire pattern 130 (that is connected to the first sensor 121) may be formed in a layer different from that of the metal wire pattern 130 that is connected to the second sensor 122, or may be insulated and separated from the metal wire pattern 130 that is connected to the second sensor 122.

Further, in the first exemplary embodiment, the touch screen panel 101 operates with a capacitive overlay. Therefore, the sensor 120 and the metal wire pattern 130 are not limited to those that are shown in FIG. 1 and can be formed in various structures that can operate in a capacitive overlay within a range that can be easily changed by a person of ordinary skill in the art.

The insulation layer 140 covers the metal wire pattern 130. The insulation layer 140 may include at least one of various suitable insulation materials, such as tetra ethyl ortho silicate (TEOS), silicon nitride (SiNx), silicon oxide (SiO₂), etc.

In the first exemplary embodiment, the ground line 181 is disposed between the edge of the substrate 111 and the metal wire pattern 130. The ground line 181 is insulated from the metal wire pattern 130 through the insulation layer 140. The ground line 181 prevents a failure from occurring in the sensor 120 as external static electricity is injected through the metal wire pattern 130. For example, when external static electricity is injected, a short circuit may occur in an intersecting (or crossing) area of the first sensor 121 and the second sensor 122 that are arranged to intersect.

The window member 300 is arranged opposite to (or to face) the substrate 111 with the sensor 120 interposed therebetween. The window member 300 may be made of a transparent insulation material composed of glass, quartz, ceramic, plastic, etc. For example, the window member 300 may be formed with tempered glass or reinforced plastic having strong impact resistance or scratch resistance.

The light blocking layer 350 is formed in one area of the window member 300 opposite to (or face) the metal wire pattern 130. The light blocking layer 350 covers a non-display area of a display panel 200 to be described later together with the metal wire pattern 130.

The adhesive layer 150 coheres (or adheres) the window member 300 to the substrate 111 while filling space between the window member 300 and substrate 150. Further, the adhesive layer 150 reduces a change of a refractive index of light. The adhesive layer 150 can use various suitable materials.

The display panel 200 displays an image with a display element 220 that is formed at a position corresponding to the sensor 120 of the touch screen panel 101. A peripheral area of the display element 220 becomes a non-display area.

The display element 220 may be an organic light emitting diode display, a liquid crystal display, an electrophoretic display, etc.

By such a configuration, the touch screen panel 101 and the display device 501 having the same according to the first exemplary embodiment can prevent a failure from occurring due to static electricity.

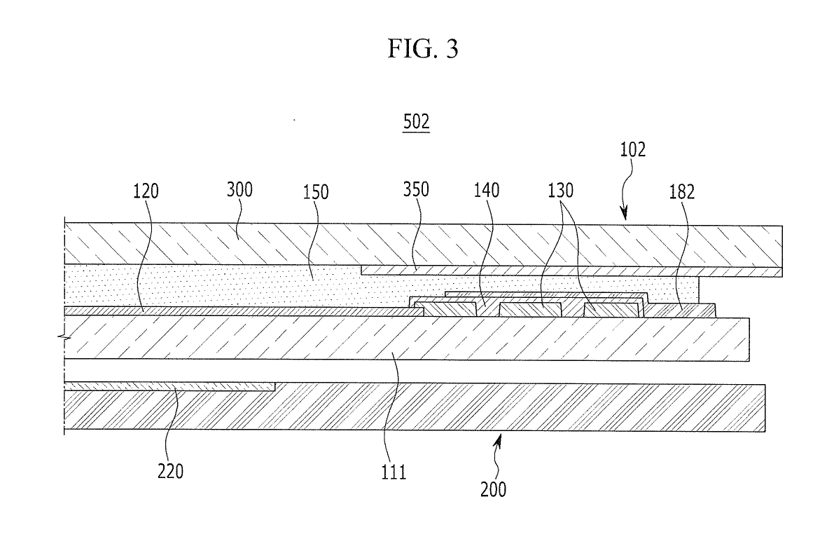

Hereinafter, a touch screen panel 102 and a display device 502 having the same according to the second exemplary embodiment will be described with reference to FIG. 3.

As shown in FIG. 3, a ground line 182 according to the second exemplary embodiment is extended from between the edge of a substrate 111 and a metal wire pattern 130 onto an insulation layer 140 that covers the metal wire pattern 130.

By such a configuration, the ground line 182 can more effectively prevent a failure from occurring in the touch screen panel 102 and the display device 502 having the same due to static electricity.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of certain symbols>

| | |
|---|---|
| 101, 102: touch screen panel | 111: substrate |
| 120: sensor | 130: metal wire pattern |
| 140: insulation layer | 150: adhesive layer |
| 181, 182: ground line | 200: display panel |
| 220: display element | 300: window member |
| 350: light blocking layer | 501, 502: display device |

What is claimed is:

1. A touch screen panel comprising:
a substrate;
a sensor at the center of the substrate;
a metal wire pattern at a periphery of the sensor and having at least a portion connected to the sensor;
an insulation layer covering the metal wire pattern; and
a ground line between an edge of the substrate and the metal wire pattern.

2. A display device comprising:
the touch screen panel of claim 1; and
a display panel facing the substrate of the touch screen panel.

3. The touch screen panel of claim 1, further comprising:
a window member facing the substrate with the sensor interposed therebetween; and
an adhesive layer filling space between the window member and the substrate.

4. A display device comprising:
the touch screen panel of claim 3; and
a display panel facing the substrate of the touch screen panel.

5. The touch screen panel of claim 3, further comprising a light blocking layer formed in an area of the window member facing the metal wiring pattern.

6. A display device comprising:
the touch screen panel of claim 5; and
a display panel facing the substrate of the touch screen panel.

7. The touch screen panel of claim 1, wherein the ground line is extended from between the edge of the substrate and the metal wire pattern, onto the insulation layer covering the metal wire pattern.

8. A display device comprising:
the touch screen panel of claim 7; and
a display panel facing the substrate of the touch screen panel.
